(19) United States
(12) Patent Application Publication
(10) Pub. No.: US 2004/0202993 A1
(43) Pub. Date: Oct. 14, 2004

(54) Apparatus and method for organ preservation and transportation

(76) Inventors: Ramon E. Poo, Miami, FL (US); Camillo Ricordi, Miami, FL (US)

Correspondence Address: Gregory A. Nelson, Esq., Akerman Senterfitt, 222 Lakeview Avenue, Suite 400, P.O. Box 3188, West Palm Beach, FL, 33402-3188, US

(21) Appl. No.: 10/410,954

(22) Filed: Apr. 10, 2003

(51) Int. Cl. A01N 1/00; A01N 1/02

(52) U.S. Cl. 435/1.1

(57) ABSTRACT

A method for storing organs, cells, and tissues, includes the steps of providing a gas impermeable container; providing a preservation solution containing dissolved oxygen; placing the preservation solution into the container with the organ, cell or tissue; and hermetically closing said container. A system for storing organs, cells, and tissue includes a gas impermeable organ container for the organs, cells and tissue. A hermetically sealable solution container is provided for storing a preservation solution. The preservation solution contains dissolved oxygen. A dispensing structure is provided for placing the solution into the organ container. The preservation solution can include an oxygen-carrier solution and UW solution. The oxygen-carrier solution can be perfluorocarbon.

### BACKGROUND OF THE INVENTION

The period between harvesting an organ and transplantation of the organ or cells from the organ into the recipient usually involves cold storage and transportation. During this period, the supply of blood, and consequently oxygen, is cut off from the organ. This period of cold ischemia is, at present, unavoidable and results in the gradual deterioration of cell function, eventually progressing to irreversible damage.

A new rapidly emerging technique for improved preservation of donor pancreata (and possibly other organs) has been established and several groups are now testing it in research and clinical trials. The technique is called the 2 layer method and calls for the utilization of a solution of perfluorocarbon (PFC) in combination with a cold storage solution such as the University of Wisconsin preservation solution (the “UW solution”). The University of Wisconsin (UW) solution contains as its primary agents lactobionate and raffinose. These compounds are too large to enter the cells and therefore remain in the extra cellular spaces. These impermeants act through osmotic forces to prevent cell swelling that would otherwise damage the stored organ.

Liver is another common organ for transplantation, as transplantation can be the only option for many patients suffering from treatable liver diseases. A successful transplantation requires that the donor liver be optimally preserved. Although the liver can be preserved for 10-20 h, cellular energy levels fall to critically low values within the first 1-4 h. The consequences of a poorly functioning transplanted liver are potentially fatal, and requires retransplantation at a significant increase in cost. It is therefore vital that adequate procedures and systems be provided for organ storage and transportation.

The current practice requires a 20-30 minute step of oxygenation of the PFC+/−UW solution before placing the organ in an appropriate container. This creates logistics problems to the procurement team that have to oxygenate the solution at the time of organ procurement or to the team receiving an organ such as the pancreas, because the team must oxygenate and provide the solution ready to be used as soon as notification has been received that an organ is available.

### DETAILED DESCRIPTION OF THE INVENTION

The invention relates to a packaging technique that would allow distribution of an improved system for cold storage organ preservation by pre-oxygenating a solution of perfluorocarbon (PFC) or similar oxygen carrier alone or in combination with a cold storage solution such as University of Wisconsin preservation solution (UW).

The invention utilizes a packaging system in which the PFC, with or without UW solution, is pre-oxygenated as a production step or in a packaging facility and loaded in a gas impermeable container so that the degree of oxygenation can be maintained within a desired range for prolonged periods of time. The invention provides a ready to use system that would be preferable compared to the current practice.

A method for storing organs, cells, and tissues, includes the steps of providing a gas impermeable container; providing a preservation solution containing dissolved oxygen; placing the preservation solution into the container with the organ, cell or tissue; and hermetically closing said container.

A system for storing organs, cells, and tissue includes a gas impermeable organ container for the organs, cells and tissue. A hermetically sealable solution container is provided for storing a preservation solution. The preservation solution contains dissolved oxygen. A dispensing structure is provided for placing the solution into the organ container.

A preferred method would include the steps of providing a gas impermeable plastic bag containing a suitable amount of UW solution, approximately 350 ml of PFC and 350-500 ml of UW cold preservation solution, in the case of transporting a pancreas. The bag is pre-filled with the solution and is oxygenated and sealed, preferably without any excess air. In an alternative embodiment, the bag is sealed after some oxygen is also included in the bag, creating an oxygen-liquid interface. The dimension of the bag is selected to allow inclusion of the desired volume of liquid or liquid-gas composition, without developing an excess pressure in the container. Alternatively, the PFC solution can be oxygenated on a larger production scale, before aliquots are packaged. The containers are rapidly filled with the pre-oxygenated solution and with the UW solution and sealed to avoid gas diffusion from the solution. The UW solution does not have to be placed into the container at the same time as the pre-oxygenated solution but can, for example, be placed into the container prior to adding the pre-oxygenated solution.

Alternatives to the PFC solution are possible. These alternative oxygen-carrier solutions should have a capacity for dissolving oxygen, and for releasing the oxygen to the organ over time. The oxygen-carrier solution must not be harmful to the organ.

Alternatives to the UW solution could also be used with the invention. Such solutions are being developed as replacements or improvements to the UW solution. These include Hypothemosol® produced by Mediatech, Inc. of Herndon Va., and Eurocollins solution.

The packages can be distributed to organ procurement organizations and procurement teams anywhere, and would be ready to use as needed. This will save valuable operating room time, as presently the team procuring the organ must spend an addition half hour in the operating room oxygenating the solution before the organ can be transported. The method could be used for preservation of organs, tissues and cells for several research and clinical applications, including but not limited to the fields of transplantation, biologic replacement, and reparative medicine.

The invention can be provided in other forms and embodiments without departing from the spirit or essential attributes thereof.

We claim:

1. A method for storing organs, cells, and tissues, comprising the steps of:
providing a gas impermeable container;
providing a preservation solution containing dissolved oxygen; and
placing the preservation solution into said container with said organ, cell or tissue; and
hermetically closing said container.

2. The method of claim 1, wherein the preservation solution comprises an oxygen-carrier solution and UW solution.

3. The method of claim 2, wherein the oxygen-carrier solution is perfluorocarbon.

4. A system for storing organs, cells, and tissue, comprising:
a gas impermeable organ container for said organs, cells and tissue;
a hermetically sealable solution container for storing a preservation solution within said container, said solution containing dissolved oxygen; and
a dispensing structure for placing said solution into said organ container.

5. The system of claim 4, wherein the preservation solution comprises an oxygen-carrier solution and UW solution.

6. The method of claim 5, wherein the oxygen-carrier solution is perfluorocarbon.
